(19) United States
(12) Patent Application Publication
(10) Pub. No.: US 2026/0120138 A1
(43) Pub. Date: Apr. 30, 2026

(54) METHODS AND SYSTEMS FOR REAL-TIME SCENARIO FORECASTING

(71) Applicant: Summer Craig Consulting LLC, Houston, TX (US)

(72) Inventors: Summer R. CRAIG, Houston, TX (US); Jordan Aaron SCOTT, Olathe, KS (US)

(73) Assignee: Summer Craig Consulting LLC, Houston, TX (US)

(21) Appl. No.: 18/925,436

(22) Filed: Oct. 24, 2024

(51) Int. Cl. G06Q 30/0207; G06Q 10/04

(52) U.S. Cl. CPC G06Q 30/0207; G06Q 10/04

(57) ABSTRACT

The present disclosure provides systems and methods for predictive analytics. For example, a system provided herein includes a data retriever implemented on a first unit configured to communicate over a data network with a second unit, a database coupled to the first unit and configured to store deal data, and a forecast toolkit implemented on a second unit configured to communicate over the data network with a remote computing device. The forecast toolkit may include a future deal manager configured to identify, within enhanced deal information, future open deals; a machine learning engine; a forecast manager configured to union the future open deals with an initial forecast to produce a second initial forecast, the initial forecast constructed by applying the machine learning engine to historical deal information; and a table builder configured to construct a predicted revenue output based on the second initial forecast.

### FIELD OF THE DISCLOSURE

The present disclosure relates generally to predictive analytic technology.

### BACKGROUND OF THE DISCLOSURE

Current revenue forecasting technology allows organizations to analyze historical data and identify revenue trends with some degree of precision. These technologies facilitate scenario planning and risk assessment, helping companies to make informed strategic decisions, optimize resource allocation, and enhance financial planning. Despite the advancements in revenue forecasting technology, several challenges persist that can impact the accuracy and reliability of forecasts. One challenge is data quality and integration. Disparate data sources, inconsistent data formats, and incomplete datasets can lead to erroneous predictions. Additionally, the complexity of machine learning models and algorithms requires specialized expertise to develop, implement, and maintain, which can be resource-intensive for organizations. Another issue is the inherent uncertainty in external factors such as market volatility, economic fluctuations, and unforeseen events, which can disrupt current forecasting models. Furthermore, over-reliance on historical data may not adequately account for rapid changes in consumer behavior or emerging market trends.

Although current techniques for revenue forecasting are based on technological advancements made over many years, current revenue forecasting techniques may still be ineffective to achieve ideal results. Accordingly, there is an impetus to improve revenue forecasting techniques to overcome current technological challenges by implementing improvements including, for example: enhancing the reliability of revenue forecasting techniques, increasing the accuracy of revenue forecasting techniques, reducing inefficiencies associated with revenue forecasting techniques, increasing the throughput of revenue forecasting techniques, reducing errors associated with revenue forecasting techniques, decreasing the cost of revenue forecasting techniques, and the like.

Consequently, there exists a need for further improvements to revenue forecasting technology to overcome the aforementioned technical challenges and other challenges not mentioned.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an aspect consistent with the present disclosure, a system for predictive analysis may include a data retriever implemented on a first unit configured to communicate over a data network with a second unit. The system may further include a database coupled to the first unit and configured to store deal data, and a forecast toolkit implemented on a second unit configured to communicate over the data network with a remote computing device. The forecast toolkit may include a future deal manager configured to identify, within a set of enhanced deal information, one or more future open deals. The forecast toolkit may further include a machine learning engine. The forecast toolkit may further include a forecast manager configured to union the one or more future open deals with an initial forecast to produce a second initial forecast, the initial forecast constructed by applying the machine learning engine to historical deal information. The forecast toolkit may further include a table builder configured to construct a predicted revenue output based on the second initial forecast.

In another aspect, a method for predictive analysis may include identifying, within a set of enhanced deal information, one or more future open deals. The method may further include training a machine learning model including. Training the machine learning model may include inputting a plurality of training data sets, the plurality of training data sets comprising known deal information. Training the machine learning model may include comparing, to the plurality of training data sets, a plurality of outputs of a training engine. Training the machine learning model may include, based on the comparing, adjusting one or more weights of the machine learning model. The method may further include unioning the one or more future open deals with a first initial forecast to produce a second initial forecast, the first initial forecast constructed by applying a machine learning engine to historical deal information. The method may further include constructing a predicted revenue output based on the second initial forecast. The method may further include displaying, at a user interface, revenue informatics based on the predicted revenue output.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various aspects and implementations disclosed herein can be used in a further aspect, consistent with the disclosure. These and other aspects and features can be appreciated from the following description of certain aspects presented herein in accordance with the disclosure and the accompanying drawings and claims.

### BRIEF DESCRIPTION OF THE DRAWINGS

FIG. 1 is a diagram of an example enhanced data processing architecture, implemented according to at least one aspect of the present disclosure.

FIG. 2 is a diagram of an example machine learning engine, implemented according to at least one aspect of the present disclosure.

FIG. 3 is a flow diagram of an example method, implemented according to at least one aspect of the present disclosure.

FIG. 4 is a diagram of a data lineage diagram, implemented according to at least one aspect of the present disclosure.

FIG. 5 is a diagram of an example auto regressive integrated moving average (ARIMA) plus machine learning model, implemented according to at least one aspect of the present disclosure.

FIG. 6 is a diagram of an example system architecture, implemented according to at least one aspect of the present disclosure.

FIG. 7 is a graph representation of example predicted revenues displayed on a user interface, implemented according to at least one aspect of the present disclosure.

FIG. 8 is a moving graph representation of example predicted revenues displayed on a user interface based on a scaled additional store value, implemented according to at least one aspect of the present disclosure.

FIG. 9 is a diagram of a unit having a revenue forecast toolkit and a revenue forecast tool, implemented according to at least one aspect of the present disclosure.

FIG. 10 is a block diagram of a computer system that may be used to implement one or more of the systems or methods described herein in accordance with certain aspects.

FIG. 11 depicts a cloud computing environment that can be used to perform one or more actions according to an aspect of the present disclosure.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to predictive analytic techniques, and more particularly to revenue forecasting using enhanced data processing techniques.

Systems and methods presented herein utilize an enhanced data processing architecture that incorporates a sophisticated machine learning engine. Specifically, systems and methods provided herein are capable of integrating financial data from, for example, enterprise resource planning (ERP) sources or accounting software with customer relationship management (CRM) data or sales pipeline data to allow real-time ‘what-if’ scenario planning. Leveraging the enhanced data processing architecture, aspects of the present disclosure may provide both descriptive and predictive analytics for efficient and accurate revenue forecasting that is fit to account for future revenue potential.

Implementation of systems and method provided herein may allow users (e.g. those in C-suite roles, board members) to quickly visualize forecasts and scenario plans, integrating data from various sources (e.g., ERP sources, CRM data, accounting sources, sales pipeline data structured data files). This visualization may be the end-point of an enhanced data processing architecture, allowing users to address critical operational issues in real-time, such as the impact of adding a salesperson or entering a new market. By automating forecast modeling via enhanced data processing architecture, extensive time (e.g., days, weeks, or months) that may be required by current systems to gather relevant data may be mitigated or eliminated. At the same time, the enhanced data processing architecture may significantly increase the quality and fidelity of the forecasts used, ensuring long-term reliability in various use cases.

### Aspects Related to Enhanced Data Processing Architecture

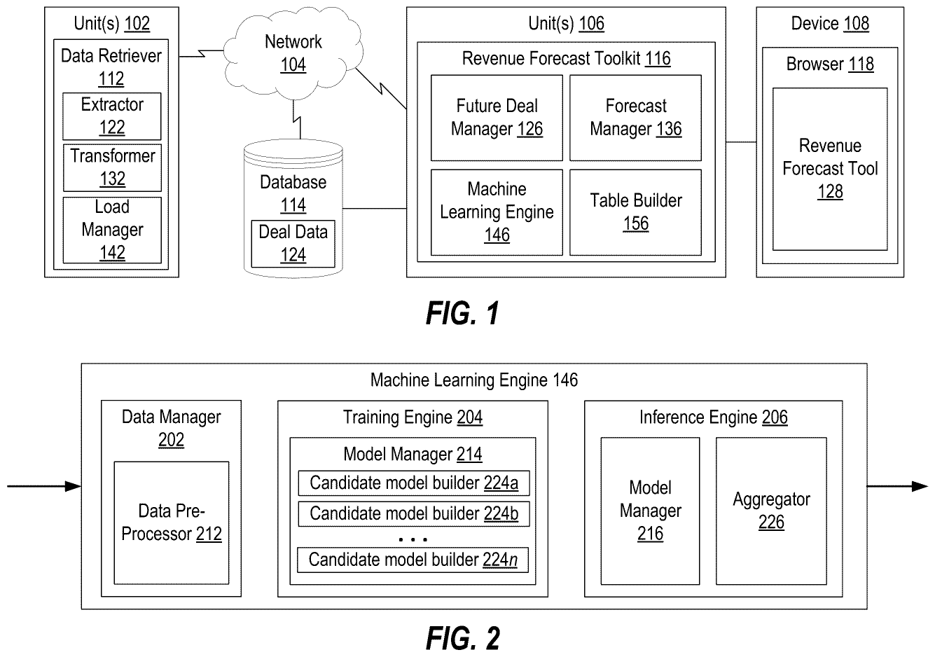

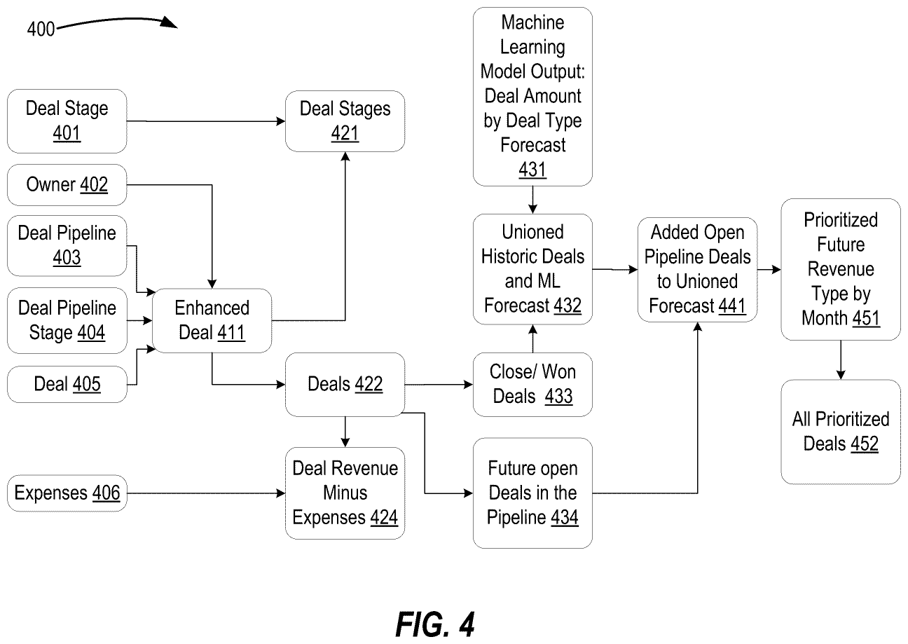

FIG. 1 illustrates an example of an enhanced data processing architecture (e.g., system), implemented according to at least one aspect of the present disclosure. In at least one aspect, the enhanced data processing architecture is configured or otherwise arranged to perform methods provided herein (e.g., method 300). In at least one aspect, the enhanced data processing architecture is configured or otherwise arranged to process data described in further detail with respect to FIG. 4. It may be understood that features of the data flow described in FIG. 4 are inherently and broadly described with respect to the enhanced data processing architecture of FIG. 1.

The enhanced data processing architecture of FIG. 1 includes unit 102, unit 106, and device 108. In at least one aspect, each of unit 102, unit 106, and/or device 108 may be practically implemented as one or more units and/or one or more devices. In at least one aspect, each of unit 102 and unit 106 may have at least one memory and one or more processors having computer readable instructions stored thereon, which are capable of implementing enhanced data processing schemes as part of the enhanced data processing architecture. In at least one aspect, unit 102, unit 106, and/or device 108 may have at least one memory and one or more processors having computer readable instructions stored thereon, which are capable of implementing enhanced data processing schemes as part of the function of the enhanced data processing architecture. The one or more processor(s) of unit 102, unit 106, and/or device 108 may be central processing units (CPUs). The one or more processor(s) of unit 102, unit 106, and/or device 108 may be graphics processing units (GPUs). Where there is more than one processor, each processor may operate independent from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data.

The enhanced data processing architecture of FIG. 1 further includes a network 104. In at least one aspect, network 104 may be practically implemented as one or more networks. Network 104 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IOT) applicability), and the like.

The enhanced data processing architecture of FIG. 1 further includes a database 114. In at least one aspect, database 114 may be practically implemented as one or more databases. In at least one aspect, the database may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Database 114 may be treated as a data warehouse, data lake, data well, or another storage system. Database 114 may be optimized for querying and analysis, allowing the enhanced data processing architecture methods described herein (e.g., method 300).

In at least one aspect, unit 102 includes a data retriever 112. Data retriever 112 includes an extractor 122, a transformer 132, and a load manager 142. In at least one aspect, extractor 122 may pull data from various platforms (e.g., CRM systems, ERP systems, HubSpot, accounting sources, sales pipeline data sources, flat files, application programming interface (API) data, and the like). In some cases, after extractor 122 pulls the data, extractor 122 may deliver the data to transformer 132. In other cases, the after extractor 122 pulls the data, extractor 122 may deliver the data to load manager 142, which then delivers the data to the transformer 132. Transformer 132 may transform the data to ensure that the data is in a suitable format for additional processing as it is processed through the enhanced data processing architecture of FIG. 1. In at least on aspect, transformer 132 may clean the data (e.g., removing duplicates, correcting errors, handling missing values to ensure data quality), may integrate the data (e.g., combining data from different sources to create a unified dataset), may transform the data (e.g., converting data into a consistent format or structure, applying business rules, aggregating data, and performing calculations or derivations as needed), and may enrich the data (e.g., enhancing the data by adding additional information or context, such as geocoding addresses or appending demographic data). In certain cases, after transformer 132 transforms the data, transformer 132 may deliver the data to load manager 142. Load manager 142 may load the data into a target data repository (e.g. by loading the data into database 114 by way of network 104).

In at least one aspect, data retriever 112 may utilize an extract-transform-load (ETL) platform (e.g., Fivetran) (not shown) to perform the steps associated with extractor 122, transformer 132, and load manager 142. The ETL platform may automate processes performed at extractor 122, transformer 132, and load manager 142 to ensure that data is consistently and accurately transferred to database 114 by way of network 104. The ETL platform may support a wide range of data sources, including databases, applications, and cloud services, and it may be configured or otherwise arranged to handle process and/or data changes automatically, ensuring that the data pipeline remains robust and adaptable to changes in the source systems. In at least one aspect, the ETL platform connectors may be configured or otherwise arranged to synchronize data at regular intervals (e.g., about every hour, about every half hour, at an interval determined suitable by a user) to ensure that the data in the warehouse is up-to-date. In at least one aspect, the ETL platform connectors may be configured or otherwise arranged to synchronize data in response to an event (e.g., a news alert, a source update alert, a user command) to ensure that the data in the warehouse is up-to-date.

In at least one aspect, database 114 includes a deal data container 124. After data is delivered at database 114, data is stored at deal data container 124, which may be practically implemented as one or more containers. In at least one example, deal data container 124 may include a data storage platform (e.g., Google BigQuery) (not shown). The data storage platform may be scalable and efficient data storage that allows for real-time data processing and querying. In at least one aspect, the data storage platform may be a fully-managed, serverless data warehouse that supports SQL queries and provides high-speed data analysis capabilities. In at least one aspect, data storage platform may be configured or otherwise arranged to handle large datasets and to scale seamlessly to accommodate growing data volumes. Where the data storage platform is implemented as BigQuery, BigQuery's integration with other services, such as Google Cloud Storage and Google Dataflow, may allow for efficient data ingestion and processing. Specifically, data may be ingested into BigQuery using batch or streaming methods, depending on the source and the required latency. As a result, the enhanced data processing system of FIG. 1 may process large volumes of data in real-time, ensuring that the data in database 114 is always current. Additionally, the enhanced data processing system may store raw and intermediate data, providing a scalable and cost-effective solution for managing large datasets.

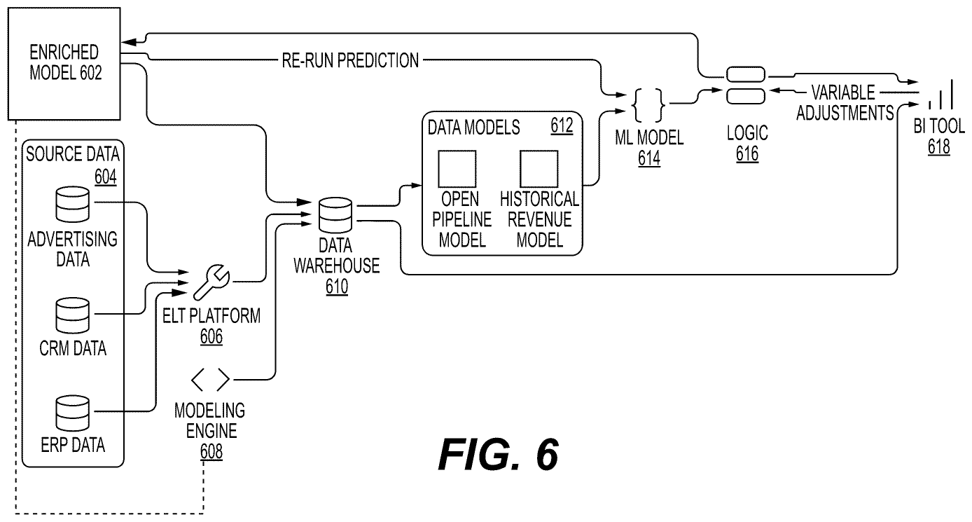

Once at deal data container 124, data may be accessed by unit 106 via network 104 to implement methods provided herein (e.g., method 300). Unit 106 includes a revenue forecast toolkit 116. In turn, revenue forecast toolkit 116 includes a future deal manager 126, a forecast manager 136, a machine learning engine 146, and a table builder 156. In at least one aspect, data accessed by unit 106 may be delivered to revenue forecast toolkit 116 by way of future deal manager 126. Future deal manager 126 may parse a set of enhanced deal information pulled from the data to identify one or more future open deals. Additionally, future deal manager 126 may apply weights to the one or more future open deals based on a pipeline stage associated with each of the one or more future open deals. Future deal manager 126 may then deliver the one or more future open deals to the forecast manager 136. Forecast manager 136 may union the one or more future open deals with an initial forecast to produce a second initial forecast. Additionally, forecast manager 136 may apply a prioritization ranking to the second initial forecast to prioritize a future revenue types by month. In at least one aspect, the first initial forecast may be constructed at machine learning engine 146, by applying machine learning engine 146 to historical deal information. The second initial forecast may be delivered to table builder 156. Table builder 156 may construct a predicted revenue output based on the second initial forecast. The predicted revenue output may be a table, a matrix or any other type of structured data optimized for subsequent interaction with device 108. After constructing the output at table builder 156, revenue forecast toolkit 116 conveys the second initial forecast and the revenue output to a logic engine (not shown, see discussion of FIG. 6). In at least one aspect, the logic engine may convey the second initial forecast and/or the revenue output to a recursive model enrichment module (not shown, see discussion of FIG. 6). In at least one aspect, the logic engine may convey the second initial forecast to device 108.

As used herein, the term “union” may refer to the process of using a structured database (e.g., SQL) to combine two different tables of data based on the criteria within a structured database query. In one example, a data table containing all open pipeline deals and the data table of the predicted deals from an initial machine learning model may be combined into a single table, with each row providing a deal type designation (e.g., an ML predicted deal or an existing deal in the pipeline that has not yet closed). Unioning data may be essential for downstream and/or following data modeling and visualizations where users can filter the future deal revenue based on the source of the prediction.

In at least one aspect, revenue forecast toolkit 116 may be an application, such as, an application running under control of an operating system on unit 106 or a web application operating which may be accessed via network 104 and via a browser 118. Unit 106 may also include or be coupled to a web server (not shown). Revenue forecast toolkit 116 may be implemented in software, firmware, hardware or any combination thereof. In at least one aspect, the revenue forecast toolkit 116 may utilize a data modeling platform (not shown) at one or more of future deal manager 126, forecast manager 136, machine learning engine 146, and the table builder 156. The data modelling platform may be a data build tool (DBT) platform. The data modelling platform may facilitate the transformation and organization of raw data from database 114 into structured, meaningful tables that are ready for analysis. This may involve creating SQL-based models that clean, aggregate, and join data from different sources. The data modelling platform may construct models that are defined using SQL and YAML Ain't Markup Language (YAML, recursive abbreviation) files. Files associated with constructed models may specify transformations and dependencies between different tables. Moreover, the models may be scheduled to run at regular intervals, ensuring that the data remains up-to-date. In at least one aspect, the data modelling platform may support version control and testing, allowing maintenance of data quality and the tracking of changes over time. The transformation logic in the data modelling platform may include operations such as filtering, aggregating, and joining tables, as well as creating derived metrics and calculated fields.

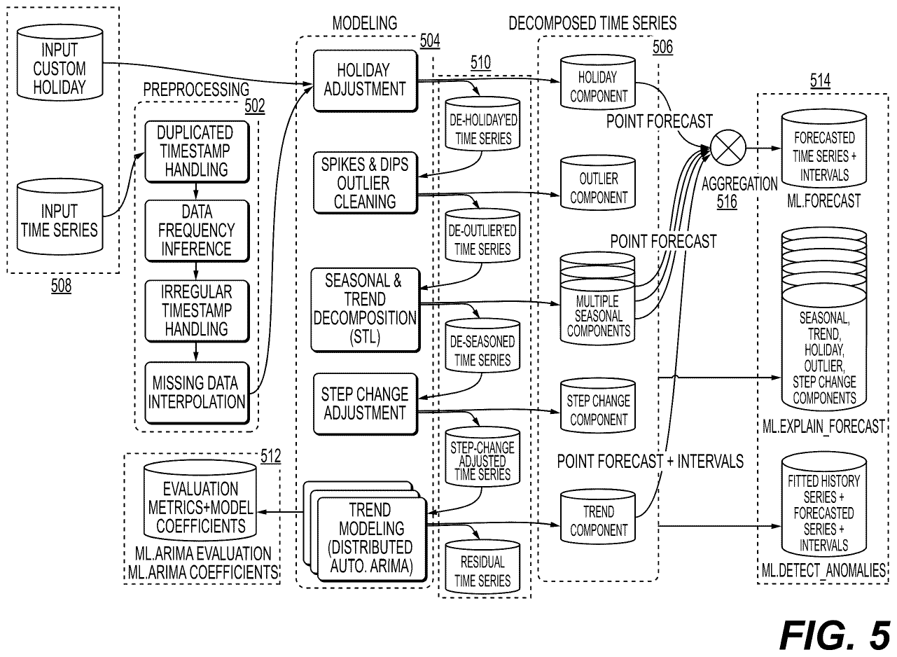

Machine learning engine 146 implemented at revenue forecast toolkit 116 is illustrated in FIG. 2. As shown in FIG. 2, machine learning engine 146 includes a data manager 202, a training engine 204, and an inference engine 206. Data manager 202 includes a data pre-processor 212, which may be configured or otherwise arranged to obtain, transform, and supply data to training engine 204, inference engine 206, or both training engine 204 and inference engine 206. Data pre-processor 212 may transform data in any manner that may be optimized for processing at either training engine 204, inference engine 206, or both training engine 204 and inference engine 206. Training engine 204 may include a model manager 214. Model manager 214 may train one or more machine learning models. In at least one aspect, training a machine learning model may include inputting a plurality of training data sets, the plurality of training data sets set including known deal information, comparing, to the plurality of training data sets, a plurality of outputs of the training engine, and based on the comparing, adjusting one or more weights of the machine learning model. Training may occur at one or more candidate model builders 224a-224n. In some cases, candidate model builders 224a-224n may be optimally configured or otherwise arranged to implement the auto regressive integrated moving average (ARIMA) plus (ARIMA+) machine learning model described in detail with respect to FIG. 5.

Inference engine 206 may include a model manager 216 and an aggregator 226. In at least one aspect, model manager 216 may be configured or otherwise arranged to obtain data from training engine 204, revenue forecast toolkit 116, deal data container 124, or some combination therein. In at least one aspect, model manager 216 may be configured or otherwise arranged to apply a machine learning model obtained from training engine 204 to data obtained from revenue forecast toolkit 116, deal data container 124, or some combination therein. In at least one aspect, model manager 216 may be configured or otherwise arranged to output a first initial forecast based on the application of the machine learning model 146 to data from revenue forecast toolkit 116, deal data container 124, or some combination therein. Aggregator 226 may be configured or otherwise arranged to aggregate, concatenate, union, combine, and/or parse output from model manager 216.

In at least one aspect, the initial machine learning model implemented at inference engine 206 may utilize an ARIMA+ model, which is well-suited for time series forecasting. An ARIMA+ model is described in further detail below. In at least one aspect, the ARIMA+ model may be trained on historical data to predict future revenue, taking into account factors such as seasonality, holidays, and other relevant variables. In at least one aspect, the ARIMA+ model may be configured or otherwise arranged to auto-adjust data frequency and handle daily, weekly, monthly, or annual data. In at least one aspect, the ARIMA+ model may output several key metrics, including seasonal effects, holiday effects, and confidence intervals. In one example, the ARIMA+ model may be implemented using BigQuery ML, which allows inference engine 206 to build and deploy machine learning models directly within BigQuery using SQL. Additionally, the model training process at training engine 204 may involve selecting the appropriate features, splitting the data into training and validation sets, and tuning the model parameters to optimize performance. In at least one aspect, the machine learning model implemented at inference engine 206 may be one or more of any other machine learning model suitable to perform methods described herein (e.g., method 300), including models that are mentioned and not mentioned in this description.

To ensure the model remains accurate, training engine 204 may retrain the machine learning model at one or more specified intervals (e.g., on a daily basis, on an hourly basis) using the latest data. This retraining process may involve running a scheduled query (e.g., in BigQuery) that updates the model with new data from about the past 24 hours. This continuous learning approach may allow the model to adapt to changes in the business environment and maintain high accuracy. The retraining process may be automated at machine learning engine 146 (e.g., using Google Cloud Scheduler), which may trigger the retraining job at the specified intervals. The retraining job may include steps to preprocess the data (e.g., at data pre-processor 212 of the data manager 202), update the model parameters, and validate the model's performance. The validation process may involve comparing the model's predictions with actual outcomes and calculating performance metrics such as mean absolute error (MAE) and root mean squared error (RMSE).

In addition to the initial machine learning model, the enhanced data processing system of FIG. 1 may implement a second layer of machine learning that blends the output of the first model with current pipeline data. This may involve taking a predicted revenue value from the most current machine learning model and combining it with a weighted revenue value from open pipeline deals. The pipeline data may be processed to account for the probability of deals closing, based on their stage in the sales process. This blended approach may provide a comprehensive forecast that reflects both historical trends and current opportunities. The second layer of machine learning may retrain the machine learning model based on this blended approach, and may be implemented (e.g., using BigQuery ML) to handle complex scenarios, such as slow or sudden changes in market conditions or new business strategies. The blending process may involve creating a composite forecast that integrates the predictions from initial model and the retrained model, using techniques such as weighted averaging or ensemble learning.

Various aspects described herein can constitute one or more technical improvements over conventional revenue forecasting operations by incorporating enhanced data processing at a logic engine to recursively adjust the data to better reflect real-time information. For example, weighting the output of the machine learning using future open deal information, pipeline stage information, and seasonal prioritization, and then using the weighted output to retrain the machine learning model facilitates low-latency, high accuracy output from the final machine learning model. Additionally, one or more aspects described herein can have a practical application by training machine learning models to perform the machine learning operations in a flexible manner in accordance with defined real-time forecasting objectives. For example, one or more aspects described herein can incorporate specific, dynamic user information into a machine learning model, making for a highly flexible machine learning model within the architecture of FIG. 1. For instance, the machine learning engine can retrain in response to an alert, the alert indicating new information which may all the machine learning model generate more precise output.

In at least one aspect, device 108 of the enhanced data processing architecture of FIG. 1 includes browser 118, which may utilize a revenue forecast tool 128. In at least one aspect, revenue forecast toolkit 116 may be accessed by device 108 via network 104. In at least one aspect, device 108 can be any electronic computing device. Device 108 may be a computing device that has a display. A user can enter control inputs through a user interface (such as a keyboard, microphone, or touchscreen). For example, device 108 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 104. In at least one aspect, device 108 may be a remote computing device that includes a forecast tool (e.g., revenue forecast tool 128) having a user-interface configured to allow a user to view revenue informatics based on a predicted revenue table on a display device and to make inputs to control visualization of the revenue informatics displayed to the user.

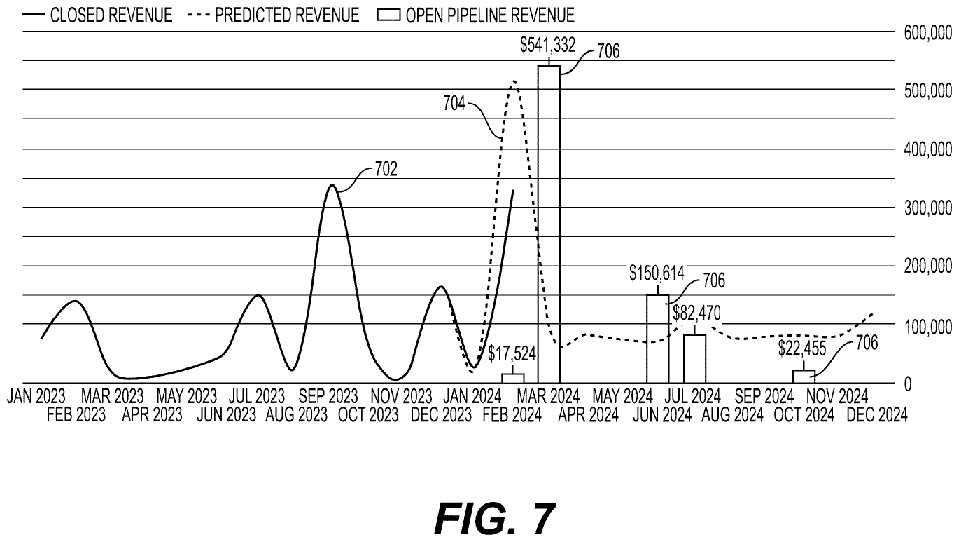

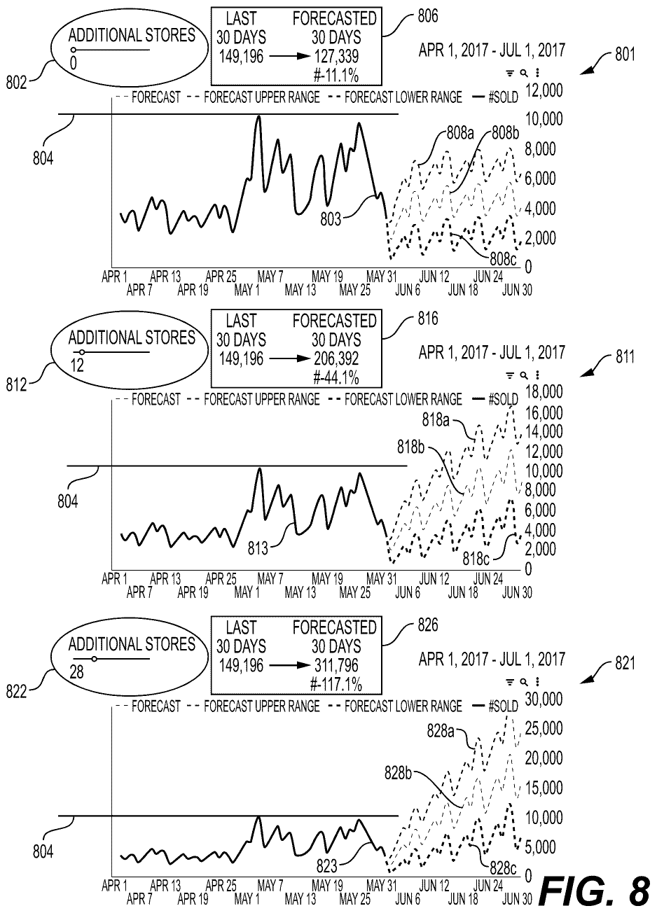

Browser 118 may include a revenue forecast tool 128. Revenue forecast tool 128 may be an application, such as, an application running under control of an operating system on unit device 108 or a web application operating which may be accessed via network 104 and via browser 118. Revenue forecast tool 128 may be configured or otherwise arranged to access data from revenue forecast tool 128 to, for example, display revenue informatics based on the predicted revenue table. In at least one aspect, revenue informatics may represent a final output of models constructed at revenue forecast toolkit 116. Visualization may be achieved by a visualizer module (e.g., Looker Studio) (not shown). The visualizer module may allow device 108 to generate interactive dashboards where users can explore the data and pull levers to see the impact of various business decisions on their forecasts. For example, users can adjust variables such as ad spending, conversion rates, number of storefronts, and the number of salespeople to see how these changes affect their revenue projections. The visualizer module may support a wide range of visualization types, including charts, graphs, and tables. The dashboards may be configured or otherwise arranged to be user-friendly and provide real-time insights. The dashboards may include features such as scenario planning, where users can model different business scenarios and see the potential outcomes. The dashboards may also integrate with other data sources (e.g., Google Ads and LinkedIn Ads) to pull in additional metrics and provide a holistic view of the business. The integration with external data sources may be achieved using the visualizer module's data connectors, which support a wide range of APIs and data formats. Additional discussion of dashboards may be found with respect to the discussion of the examples of FIG. 7 and FIG. 8.

In at least one additional aspect, the enhanced data processing architecture of FIG. 1 may include several advanced features to further enhance its functionality. One such feature is the ability to segment data by different dimensions, such as by customer type, by product category, or by geographic region. This may allow users to perform detailed analysis and to identify trends and patterns within specific segments of their business. The segmentation may be implemented using the data modelling platform to generate additional tables and views based on the specified dimensions. The segmentation logic may include operations such as filtering, grouping, and aggregating data, as well as creating calculated metrics for each segment.

In at least one additional aspect, the enhanced data processing architecture of FIG. 1 may utilize serverless computing, allowing the architecture to implement custom features (e.g., custom code) in response to specific events, such as data updates or user actions.

In at least one additional aspect, the enhanced data processing architecture of FIG. 1 may perform predictive scenario analysis. Predictive scenario analysis may involve using machine learning models (e.g., generated at machine learning engine 146) to construct different business scenarios and predict their impact on key metrics, such as revenue, profit, and customer acquisition costs. As part of the predictive scenario analysis feature, users can define custom scenarios by adjusting various input parameters, such as marketing spending, sales team size, and pricing strategies. The predictive scenario analysis may be implemented using a combination of data storage platform and machine learning engine 146, which may allow the architecture to generate and analyze multiple scenarios in parallel. The scenario analysis process may include steps such as defining the scenario parameters, running simulations, and comparing the results with a baseline forecast.

In at least one additional aspect, enhanced data processing architecture of FIG. 1 may include a comprehensive reporting and alerting system. As part of the comprehensive reporting and alerting system, users can schedule regular reports that provide detailed insights into their business performance and highlight any deviations from the forecast. The reports may be generated using the visualization module and can be customized to include specific metrics and visualizations. The comprehensive reporting and alerting system is configured or otherwise arranged to notify users of any significant changes or anomalies in the data, such as unexpected drops in revenue or spikes in customer churn. The alerts are implemented using an alert module (e.g., Google Cloud Functions and Pub/Sub), which allows the architecture to monitor data in real-time and trigger notifications based on predefined thresholds. The alerting logic may include steps such as defining the alert conditions, monitoring the data streams, and sending notifications via email or other communication channels.

In at least one additional aspect, the enhanced data processing architecture of FIG. 1 may be arranged or otherwise configured as modular and extensible, allowing users to add new features and integrations as needed. The core components, such as data retriever 112, database 114, revenue forecast toolkit 116, and revenue forecast tool 128, may be loosely coupled, allowing dynamic enhancements to individual components without affecting the overall system. This modular design also allows for elevated customization options (e.g., bespoke options) for the enhanced data processing architecture.

### Example Method

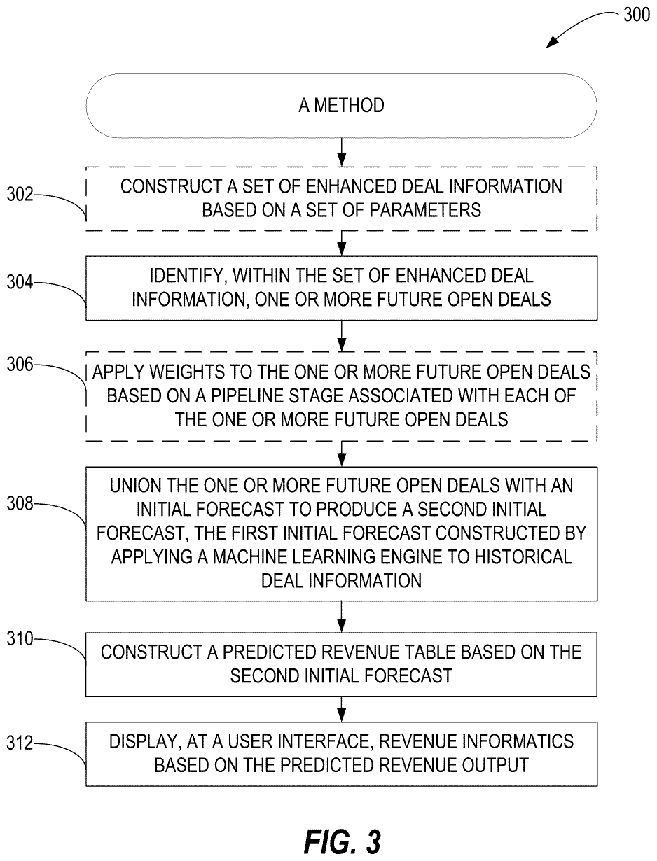

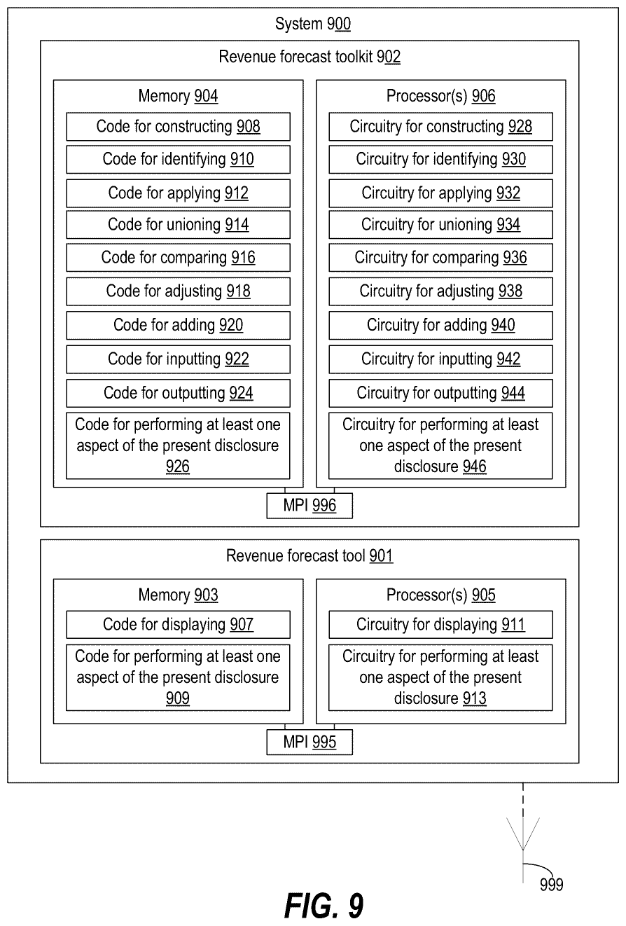

FIG. 3 is a schematic flowchart of an example method 300 for revenue forecasting by one or more processors, such as processors of enhanced data processing architecture of FIG. 1, the system of FIG. 6, and/or the processors of the system 900 of FIG. 9.

Method 300 optionally begins at operation 302 with one or more processors constructing a set of enhanced deal information based on a set of parameters. In at least one example, the set of parameters may include a pipeline stage for each of a set of deals within the enhanced deal information. In at least one example, the set of parameters may include at least one of an owner for each of a set of deals within the enhanced deal information, a pipeline for each of a set of deals within the enhanced deal information, and a title for each of a set of deals within the enhanced deal information. In at least one example, the set of parameters may include at least one of a company for each of a set of deals within the enhanced deal information, a contact for each of a set of deals within the enhanced deal information, and a property history for each of a set of deals within the enhanced deal information.

Method 300 continues to operation 304 with one or more processors identifying, within or at the set of enhanced deal information, one or more future open deals.

Method 300 optionally continues to operation 306 with one or more processors applying weights to the one or more future open deals based on a pipeline stage associated with each of the one or more future open deals.

Method 300 continues to operation 308 with one or more processors unioning the one or more future open deals with an initial forecast to produce a second initial forecast, the first initial forecast constructed by applying a machine learning engine to historical deal information. In at least one example, the machine learning engine includes a training engine which may be configured or otherwise arranged to train a machine learning model and an inference engine which may be configured or otherwise arranged to apply the machine learning model to the historical deal information.

Method 300 continues to operation 310 with one or more processors constructing a predicted revenue table based on the second initial forecast.

Method 300 optionally continues to operation 312 with one or more processors displaying, at a user interface, revenue informatics based on the predicted revenue output.

In at least one aspect, method 300 may include an operation by one or more processors to train a machine learning model. In at least one example, training a machine learning model may be performed via a training engine configured to train a machine learning model.

In at least one aspect, method 300 may include an operation by one or more processors to input a plurality of training data sets, the plurality of training data sets set including known deal information.

In at least one aspect, method 300 may include an operation by one or more processors to compare, to the plurality of training data sets, a plurality of outputs of the training engine.

In at least one aspect, method 300 may include an operation by one or more processors to adjust one or more weights of the machine learning model. In one example, adjusting is based on comparing, to the plurality of training data sets, a plurality of outputs of the training engine.

In at least one aspect, method 300 may include an operation by one or more processors to apply a prioritization ranking to the second initial forecast to prioritize a future revenue types by month. In at least one example, applying may be a component of constructing the final forecast based on the second initial forecast.

In at least one aspect, method 300 may include an operation by one or more processors to add closed pipeline information to the second initial forecast. In at least one example, applying may be a component of constructing the final forecast based on the second initial forecast.

In one aspect, method 300, or any aspect related to it, may be performed by a system, device, apparatus, or architecture, such as the enhanced data processing architecture of FIG. 1 or system 900 of FIG. 9, which includes various components operable, configured to, or adapted to perform the method 300. System 900 is described below in further detail.

FIG. 3 is just one example of a method, and other methods including fewer, additional, or alternative operations are contemplated consistent with the disclosure.

### Aspects Related to Data Lineage at an Enhanced Data Processing Architecture

FIG. 4 illustrates an example data lineage graph representing data flow 400 through an enhanced data processing architecture (e.g., an enhanced data processing architecture of FIG. 1). At the start of data flow 400, deal stage data 401, owner data 402, pipeline data 403, deal stage pipeline data, and additional deal data 405 may be combined to construct enhanced deal data 411. Enhanced deal data 411 is combined with deal stage data 401 to construct deal stages data 421. Enhanced deal data 411 is also forwarded through the enhanced data processing architecture as deals data 422. Deals data 422 is combined with expenses data 406 to construct deal minus expenses data 424. Deals data 422 is also forwarded through the enhanced data processing architecture to identify closed and won deals 433. Deals data 422 is also forwarded through the enhanced data processing architecture to identify future open deals in the pipeline 434. The closed and won deals 433 are combined with a machine learning model output 431 to construct unioned historic deals and machine learning forecast information 432. Unioned historic deals and machine learning forecast information 432 is combined with future open deals in the pipeline 434 to add open pipeline deals to the unioned forecast to construct added open pipeline deals to the unioned forecast 441. A prioritization ranking may be applied to added open pipeline deals to the unioned forecast 441 to construct prioritized future revenue type by month data 451. Prioritized future revenue type by month data 451 is forwarded through the enhanced data processing architecture to construct all prioritized deal data 452.

The following components of the data flow 400 may include, but are not limited to, data as described in the examples below.

Deal stage data 401: Data obtained by an enhanced data processing architecture regarding the stage and/or status of one or more past, present, or future financial and/or contractual deals associated with a set of identified business and/or personal entities.

Owner data 402: Data obtained by an enhanced data processing architecture regarding the owner of one or more assets or accounts related to past, present, or future financial and/or contractual deals associated with a set of identified business and/or personal entities.

Deal pipeline data 403: Data obtained by an enhanced data processing architecture regarding the pipeline and/or field of business related to past, present, or future financial and/or contractual deals associated with a set of identified business and/or personal entities.

Deal pipeline stage data 404: Data obtained by an enhanced data processing architecture regarding the stage and/or status of the pipeline and/or field of business related to past, present, or future financial and/or contractual deals associated with a set of identified business and/or personal entities.

Deal data 405: Data obtained by an enhanced data processing architecture regarding additional information related to past, present, or future financial and/or contractual deals associated with a set of identified business and/or personal entities.

Expenses data 406: Data obtained by an enhanced data processing architecture regarding business expenses of a set of identified business and/or personal entities.

Enhanced deal data 411: Data constructed by an enhanced data processing architecture, based on obtained data, regarding information related to past, present, or future financial and/or contractual deals associated with a set of identified business and/or personal entities.

Deal stages data 421: Data processed by an enhanced data processing architecture, based on constructed data, regarding the stage and/or status of past, present, or future financial and/or contractual deals associated with a set of identified business and/or personal entities.

Deals data 422: Data processed by an enhanced data processing architecture, based on constructed data, regarding information related to past, present, or future financial and/or contractual deals associated with a set of identified business and/or personal entities.

Deal minus expenses data 424: Data processed by an enhanced data processing architecture, based on obtained and constructed data, regarding (1) information related to past, present, or future financial and/or contractual deals associated with a set of identified business or personal entities, and (2) business expenses of a set of identified business and/or personal entities.

Machine learning model output 431: Data processed by an enhanced data processing architecture, via a machine learning engine, regarding deal value and deal type forecasting related to past, present, or future financial and/or contractual deals associated with a set of identified business and/or personal entities.

Unioned historic deals and machine learning forecast information 432: Data processed by an enhanced data processing architecture, based on constructed data, regarding (1) information related to past financial and/or contractual deals associated with a set of identified business and/or personal entities, and (2) deal value and deal type forecasting related to past, present, or future financial and/or contractual deals associated with a set of identified business and/or personal entities.

Closed and won deals 433: Data processed by an enhanced data processing architecture, based on constructed data, regarding information related to past financial and/or contractual deals associated with a set of identified business or personal entities.

Future open deals in the pipeline 434: Data processed by an enhanced data processing architecture, based on constructed data, regarding information related to present and/or future financial and/or contractual deals associated with a set of identified business and/or personal entities.

Added open pipeline deals to the unioned forecast 441: Data processed by an enhanced data processing architecture, based on processed data, regarding (1) information related to past financial and/or contractual deals associated with a set of identified business and/or personal entities (2) deal value and deal type forecasting related to past, present, or future financial and/or contractual deals associated with a set of identified business and/or personal entities, and information related to present and/or future financial and/or contractual deals associated with a set of identified business and/or personal entities.

Prioritized future revenue type by month data 451: Data processed by an enhanced data processing architecture, based on processed data, regarding the unioned forecast 441, prioritized by month.

In at least one aspect, the data within the data flow 400 may be data accessible to the enhanced data processing architecture of FIG. 1. For example, an ERP, an accounting platform, a CRM platform, and a sales pipeline platform may need to be extractable by a data retriever. In certain cases, extractability may be achieved via a pre-built integration with an ETL platform, an available API, or a scheduled comma separated value (CSV) reporting capability.

In at least one aspect, the data within the data flow 400, may be assigned a “unique identifier” linking pipeline deals/sales with financial invoices/transactions. In one example, this may be an order number, a deal identifier (ID), an auto-generated key, and the like.

### Example Arima+ Model

FIG. 5 is a diagram of an example ARIMA+ model, implemented according to at least one aspect of the present disclosure. The following description may be further understood with reference to FIG. 5.

An ARIMA model is an analysis technique for time series forecasting. It combines three key components: autoregression (AR), differencing (I), and moving average (MA). The AR component includes regressing a given variable on its own lagged (e.g., past) values, capturing the relationship between an observation and a number of lagged observations. The I component may be used to make the time series stationary, which means that the mean and variance are constant over time, by subtracting the previous observation from the current observation. The MA component may model the relationship between an observation and a residual error from a moving average model applied to lagged observations. Often, an ARIMA model is denoted as ARIMA (p, d, q), where ‘p’ represents the number of lagged observations in the model (e.g., autoregressive terms), ‘d’ is the number of times the raw observations are differenced, and ‘q’ is the size of the moving average window. ARIMA models may be particularly effective for short-term forecasting and are capable of handling various types of time series data, including those with trends and seasonality. The model parameters may be estimated using maximum likelihood estimation, and the model's performance is may be evaluated using criteria such as the Akaike Information Criterion (AIC) or Bayesian Information Criterion (BIC) to ensure the best fit.

The ARIMA+ model is an advanced extension of the traditional ARIMA model. The ARIMA+ may be configured or otherwise arranged to enhance time series forecasting capabilities by incorporating additional features and handling more complex data patterns. While it retains the core components of ARIMA—autoregression (AR), differencing (I), and moving average (MA)—an ARIMA+ model integrates several preprocessing and modeling techniques to improve accuracy and robustness. Key enhancements include automatic detection and handling of irregular time intervals, duplicated timestamps, and missing data through local linear interpolation. An ARIMA+ model may also include advanced outlier detection and adjustment mechanisms for spikes, dips, and abrupt level changes. An ARIMA+ model can identify multiple seasonal patterns within a single time series using seasonal and trend decomposition via Loess (STL) and can extrapolate seasonality with double exponential smoothing (ETS). The model may employ an “AUTO_ARIMA” procedure for automatic hyperparameter tuning, training dozens of candidate models in parallel (e.g., at candidate model builders 224a-n of FIG. 2) and selecting the best one based on a lowest AIC. Additionally, an ARIMA+ model may support holiday effect modeling and can handle large-scale time series forecasting, making it suitable for complex, real-world datasets. This model may be particularly useful for scenarios requiring high accuracy and the ability to adapt to various data irregularities and seasonal patterns, such as those considered in accordance with methods and systems of the present disclosure.

As shown in FIG. 5, an ARIMA+ model includes a preprocessing module 502, a modelling module 504, and a decompose time series module 506. Preprocessing module 502 obtains information from data module 508. Data module 508 includes input custom holiday information and input time series information. Preprocessing module 502 duplicates timestamp handling, infers data frequency, handles irregular timestamps, and interpolates missing data. Preprocessing module 502 delivers its output to modelling module 504. At modelling module 504, the ARIMA+ model performs a holiday adjustment on the data, cleans outliers (e.g., spikes and dips), performs STL, adjusts step change, performs trend modelling (e.g., using AUTO_ARIMA). After trend modelling, modelling module 504 delivers output of the trend modelling to a data module 512 that stores evaluation metrics and model coefficients. After trend modelling, modelling module 504 delivers outputs from the holiday adjustment on the data, the cleaned outliers, the STL, the adjusted step change, and the trend modelling to a data module 510 configured or otherwise arranged to decontextualize the received data. Data module 510, at a set of data wells, removes holiday context from the holiday adjustments, removes outlier context from the outlier adjustments, removes STL context from the STL adjustments, removes step change context from the step change adjustments, and stores the trend modelling output as a residual time series. Additionally, data module 510 delivers the results of the removals to modelling module 504 for recursive comparison and adjustment of the plurality of models within the ARIMA+ model scheme.

Next, modelling module 504 delivers outputs from the holiday adjustment on the data, the cleaned outliers, the STL, the adjusted step change, and the trend modelling to a decomposed times series module 506 configured or otherwise arranged to perform a time series decomposition in the received data. Decomposed time series module 506 includes a holiday component, an outlier component, multiple seasonal components, a step change component, and a trend component. Decomposed times series module 506 converts the holiday component to a first point forecast, converts the multiple seasonal components to a second point forecast, and converts the multiple seasonal components to a third point forecast and interval information. The first point forecast, the second point forecast, the third point forecast, and the interval information are combined at an aggregator 516. Aggregator 516 delivers the combined data to a data module 514. Data module 514 stores the combined data as forecasted times series and intervals. At the same time, decomposed times series module 506 delivers non-combined information to a seasonal, trend, holiday, outlier, and step change data well within data module 514, and delivers non-combined information to fitter history series, forecasted series, and interval data wells within data module 514.

Forecasting occurs within an ARIMA+ model during a model creation process. “ML. FORECAST” and “ML. EXPLAIN_FORECAST” functions can be used to retrieve forecasting values and compute prediction intervals. A time series modeling pipeline applied to an ARIMA+ model may include multiple modules. For large-scale time series forecasting, an ARIMA+ may allow simultaneous forecasting of up to about 100,000,000 time series using a “TIME_SERIES_ID_COL” option, which allows parallel processing of different modeling pipelines. In at least one aspect, an ARIMA+ model may include various options for model customization. For example, an ARIMA+ model may allow a user to specify a model type, a time series timestamp column, a data column, an ID column, a forecast horizon, and the like.

Examples of creating ARIMA+ models include forecasting a single time series, forecasting multiple time series using a single query, and improving training speed by using a fraction of the time points or defining a maximum number of time points.

### Additional Aspects Related to Enhanced Data Processing

FIG. 6 is a diagram of an example system architecture, implemented according to at least one aspect of the present disclosure. The example system architecture may be considered non-limiting. The example system architecture of FIG. 6 may be similar to the enhanced data processing architecture of FIG. 1, such that description of the enhanced data processing architecture of FIG. 1 may be considered applicable to any portion of the example system architecture of FIG. 6.

As shown in FIG. 6, the example system architecture includes an enriched model 602, a source data module 604, an ETL platform 606, a modelling engine 608, a data warehouse 610, a data module unit 612, an ML model 614, a logic engine 616, and a BI (business intelligence) tool 618. Source data module 604 includes advertising data, CRM data, and ERP data. Source data module 604 delivers the advertising data, the CRM data, and the ERP data to ETL platform 606 (e.g., by way of a network, such as the network 104 of FIG. 1). After receiving the data, the ETL platform 606 processes the data and forwards the processed data to data warehouse 610 (e.g., by way of a network, such as network 104 of FIG. 1). Additionally, modelling engine 608 delivers modelling output to data warehouse 610. The modelling output may include, for example, any constructed or processed data described with reference to FIG. 3. The modelling output may include, for example, machine learning output delivered from enriched model 602.

After receiving various data, data warehouse 610 delivers data to data module unit 612. In certain cases, data warehouse 610 also delivers data to BI tool 618. At data module unit 612, data may be processed, for example, via an open pipeline model, a historical revenue model, and/or any other suitable module, either alone or in combination. After processing, the processed data may be delivered to ML model 614 (e.g., housed at a machine learning engine), where ML model 614 is applied to the processed data. The output of ML model 614 may then be delivered to logic engine 616. Logic engine 616 evaluates the of output of ML model 614 (e.g., based on the quality of the output, based on additional considerations) and either sends the results to enriched model 602 for adjustment and subsequent reprocessing through ML model 614, or adjusts the output of ML model 614 for delivery to BI tool 618.

In at least one aspect, ETL platform 606 is configured or otherwise arranged to pull data from various sources into data warehouse 610. The data may represent multiple data sources being integrated. Once the data reaches data warehouse 610, data warehouse 610 may organize the data into specific tables and datasets. Models managed by data module unit 612 (e.g., a data modelling module, DBT, and the like) may then be applied to transform and blend the data. These models may be triggered whenever new data arrives and may apply a set of predefined or customized transformations.

In at least one aspect, the initial set of models at data module unit 612 are run to produce a forecast output, which is then stored back in data warehouse 610. This output may also be blended with additional data and run through ML model 614 iteratively, recursively applying logic engine 616 and producing enriched model 602. This process can repeat multiple times, with each iteration refining the forecast and incorporating more data. The final output is then visualized at BI tool 618.

FIG. 7 is a graph representation of example predicted revenues displayed on a user interface (e.g., BI tool 618 of FIG. 6, device 108 of FIG. 1, system 900 of FIG. 9) implemented according to at least one aspect of the present disclosure. In one aspect, the user interface may be considered a dashboard. The graph is plotted with respect to per-month time on the x-axis and revenue on the y-axis. Per-month time on the x-axis displays past, present, and future monthly values in order to allow a user to compare actual revenue to projected revenue. Trend line 702 represents revenue value displayed for past and present revenue, which may be considered actual historic revenue for a given entity. Trend line 704 represents forecasted revenue value and may be constructed based on output generated by systems and method described herein. For example, the trend line 704 may be constructed based on output from the logic engine 616 of FIG. 6 or from the revenue forecast toolkit 116 of FIG. 1. Graph bars 706 represent estimate open pipeline revenue for a given month, as compiled by systems and methods provided herein. For example, the graph of FIG. 7 indicates an open pipeline revenue of $541,332 for the “future” month of March 2024.

FIG. 8 is a moving graph representation of example predicted revenues displayed on a user interface based on a scaled additional store value, implemented according to at least one aspect of the present disclosure. In one aspect, the user interface may be considered a dashboard. At 801, a user may set an “additional stores” value 802 to zero. The resulting graph will display a trend line 803, representing revenue value displayed for past and present revenue, which may be considered actual historic revenue for a given entity. In the example of FIG. 8, the trend line 803 may indicate a maximum actual value 804 of between about $10,000 and about $12,000. The resulting graph will also provide a forecast box 806 presenting a predicted revenue forecast and a set of forecast trendlines 808a-c. The trendline 808b represents a measure of central tendency for the forecast (e.g., mean, median, mode, etc.). The trendline 808a represents an upper bound of deviation (e.g., standard deviation, variance) for the forecast. The trendline 808c represents a lower bound of deviation for the forecast. In the example of FIG. 8, the forecast box 806 indicates an about 30 day forecast for a business entity, indicating a decrease from $149,196 to $127,339 forecasted. The trendlines 808a-c generally indicate a decrease in revenue value with respect to trend line 803.

At 811, a user may set an “additional stores” value 812 to twelve. The resulting graph will display a trend line 813, representing revenue value displayed for past and present revenue, which may be considered actual historic revenue for a given entity. In the example of FIG. 8, the trend line 813 may indicate a maximum actual value 804 of between about $10,000 and about $12,000. The resulting graph will also provide a forecast box 816 presenting a predicted revenue forecast and a set of forecast trendlines 818a-c. The trendline 818b represents a measure of central tendency for the forecast (e.g., mean, median, mode, etc.). The trendline 818a represents an upper bound of deviation (e.g., standard deviation, variance) for the forecast. The trendline 818c represents a lower bound of deviation for the forecast. In the example of FIG. 8, the forecast box 816 indicates an about 30 day forecast for a business entity, indicating an increase from $149,196 to $206,392 forecasted. The trendlines 818a-c generally indicate an in revenue value with respect to trend line 813.

At 821, a user may set an “additional stores” value 822 to twenty-eight. The resulting graph will display a trend line 823, representing revenue value displayed for past and present revenue, which may be considered actual historic revenue for a given entity. In the example of FIG. 8, the trend line 823 may indicate a maximum actual value 804 of between about $10,000 and about $12,000. The resulting graph will also provide a forecast box 826 presenting a predicted revenue forecast and a set of forecast trendlines 828a-c. The trendline 828b represents a measure of central tendency for the forecast (e.g., mean, median, mode, etc.). The trendline 828a represents an upper bound of deviation (e.g., standard deviation, variance) for the forecast. The trendline 828c represents a lower bound of deviation for the forecast. In the example of FIG. 8, the forecast box 826 indicates an about 30-day forecast for a business entity, indicating an increase from $149,196 to $311,796 forecasted. The trendlines 828a-c generally indicate an in revenue value with respect to trend line 823.

By utilizing systems and methods provided herein by way of a dashboard or visualizer, users may access enhanced data processing to obtain relevant forecasts in real-time, allowing users to continuously use these insights to guide marketing and sales strategies. In addition to the “additional stores” consideration illustrated in FIG. 8, users can input other parameters, such as the number of new hires, their expected productivity, the associated costs, and the like. In response, systems and methods provided herein may then provide a range of possible outcomes, showing how these changes could impact a company's customer acquisition cost (CAC), revenue growth, and profitability. The following use cases provide non-limiting examples of the benefit of using systems and methods provided herein.

Example 1: A chief financial officer (CFO) (or a chief executive officer (CEO)) may prefer to have the ability to see forecasts related to three major deals are poised to close next month, all originating from paid advertisements. With real-time insight and data visualization from systems and methods provided herein, the CFO can immediately approve increases in ad spending to sustain the momentum generated by these ads, rather than waiting until the deals close. Traditionally, the marketing department would wait to present the results of the paid ads until after the deals have closed, and only then request approval for additional ad spending. By that time, weeks may have passed, and market conditions or seasonality may have shifted, potentially diminishing the effectiveness of the ads. The proactive approach made accessible my systems and methods provided herein allows the CFO to capitalize on current market conditions and the effectiveness of ongoing ad campaigns. By making strategic, data-driven decisions weeks or even months earlier than before, the CFO can help a business entity maintain and even accelerate its growth trajectory. This capability not only optimizes resource allocation but also enhances the agility of the organization, allowing it to respond swiftly to market opportunities and challenges. Furthermore, this real-time decision-making process fosters better alignment between the finance and marketing departments. It ensures that marketing efforts are continuously supported and optimized, leading to more consistent and predictable revenue streams. The ability to act on real-time data can also improve overall business performance, as it reduces the lag between recognizing an opportunity and acting, thereby maximizing the return on investment for marketing expenditures.

Example 2: Consider a business where each new sale necessitates potentially hiring new employees to manage the account. By integrating future pipeline deals with historical financial data, as performed by systems and methods provided herein, the business can pre-plan its hiring efforts with greater confidence and precision. For instance, a software-as-a-service (Saas) company may anticipate a surge in new customer accounts based on its current sales pipeline. Traditionally, the company might wait until these deals are finalized before initiating the hiring process, leading to a lag in service delivery and potential customer dissatisfaction. However, by leveraging computer-implemented systems and methods provided herein, the company can forecast the likelihood of these deals closing and the subsequent demand for additional staff. This approach allows the business to proactively recruit and train new hires, ensuring they are ready to manage new accounts as soon as the deals are closed. The computer-implemented systems and methods provided herein also allow the company to allocate resources more efficiently, avoiding the pitfalls of overstaffing or understaffing. By aligning hiring efforts with projected sales, the business can maintain a high level of service quality and customer satisfaction. Moreover, this data-driven strategy can help the company identify the optimal timing for recruitment campaigns, considering factors such as seasonality, market trends, and historical hiring success rates. The systems and methods provided herein may also provide data visualization and computer-implemented insight into the type of skills and expertise that may be in demand, allowing the company to tailor its recruitment efforts accordingly. In summary, computer-implemented systems and methods provided herein may allow a business to make informed, strategic decisions about hiring. This not only enhances operational efficiency but also supports sustainable growth by ensuring that the company is well-prepared to meet future demands.

Example 3: Marketing teams often face the challenge of not knowing how well their campaigns are performing until the end of the sales cycle, which can sometimes last weeks or even months. This delay in feedback can hinder their ability to make timely adjustments and optimize their strategies. However, by utilizing computer-implemented systems and methods provided herein on future deals with lead attribution intact, marketing teams can make quicker, more efficient decisions and demonstrate proof of success much earlier in the marketing process. For example, consider a marketing team running a multi-channel campaign aimed at generating leads for a new product. Traditionally, the marketing team would have to wait until the sales cycle concludes to evaluate the campaign's effectiveness, relying on metrics such as time to close, cost per lead (CPL), and customer acquisition cost (CAC). This retrospective analysis, while valuable, often comes too late to make impactful changes to the ongoing campaign. By integrating implemented systems and methods provided herein, the marketing team can analyze future deals in real-time, attributing leads to specific campaigns and channels. This allows them to forecast the potential success of their efforts based on historical deal data and key performance indicators (KPIs). For instance, implemented systems and methods provided herein allow users to compare the current Time to Close, CPL, and CAC with historical averages to identify trends and make data-driven adjustments on the fly. This proactive approach allows the marketing team to optimize their campaigns continuously, reallocating resources to the most effective channels and strategies. It also provides early indicators of success, allowing them to demonstrate the value of their efforts to stakeholders much sooner. This can be particularly beneficial in securing an additional budget or support for high-performing campaigns. Moreover, the implemented systems and methods provided herein also can help identify potential issues before they become critical. For example, if the data indicates that leads from a particular channel are taking longer to convert than expected, the marketing team can investigate and address the issue promptly, rather than waiting until the end of the sales cycle. In summary, leveraging implemented systems and methods provided herein alongside lead attribution allows marketing teams to make faster, more informed decisions, optimize their campaigns in real-time, and provide early proof of success. This not only enhances the efficiency and effectiveness of their efforts but also supports better alignment with sales and overall business objectives.

Example 4: Middle-market portfolio companies often face the challenge of managing multiple growth initiatives simultaneously, which can strain their resources and operational capacity. By leveraging the computer-implemented systems and methods provided herein, these companies can gain real-time insights into their operational metrics and financial performance, enabling more strategic decision-making. For instance, consider a middle-market portfolio company that is evaluating the potential acquisition of a smaller competitor. Traditionally, the company would conduct extensive due diligence, which could take several months and involve significant manual effort to gather and analyze data. This delay can result in missed opportunities or suboptimal decision-making due to outdated information. However, with the real-time data integration and visualization capabilities provided herein, the company can streamline its due diligence process. By integrating financial data, market trends, and operational metrics from both the target company and its own operations, the portfolio company can quickly assess the potential impact of the acquisition on its overall performance. This includes evaluating synergies, identifying potential risks, and forecasting future financial outcomes. For example, the systems and methods provided herein can analyze historical performance data to predict how the acquisition might affect key metrics such as revenue growth, profit margins, and cash flow. This allows the company to make more informed decisions about whether to proceed with the acquisition and at what valuation. Additionally, the real-time insights can help the company identify areas where operational efficiencies can be gained post-acquisition, such as through the integration of supply chains or the consolidation of administrative functions. Moreover, the proactive approach enabled by these systems and methods allows the portfolio company to act swiftly on acquisition opportunities, reducing the time to close deals and increasing the likelihood of successful integration. This agility is particularly important in competitive markets where timing can be a critical factor in securing advantageous deals.

Aspects of the present disclosure leverage advanced data analytics and machine learning techniques to provide businesses with highly accurate and actionable insights. These technologies allow organizations to analyze vast amounts of historical data, identify patterns, and predict future revenue trends with greater precision than existing methods. By incorporating real-time data and external factors such as market conditions, economic indicators, and competitive landscape, the computer-implemented systems and methods provided herein can dynamically adjust predictions, allowing businesses to respond swiftly to changing circumstances. Additionally, these technologies facilitate scenario planning and risk assessment, helping companies to make informed strategic decisions, optimize resource allocation, and enhance financial planning. The integration of serverless and/or cloud-based platforms ensures scalability and accessibility, allowing cross-functional teams to collaborate seamlessly and maintain a unified view of financial health. Overall, the adoption of aspects provided herein can lead to improved accuracy, efficiency, and strategic agility, ultimately driving better business outcomes.

### Example Systems

FIG. 9 illustrates a schematic diagram of an example system 900, which includes a revenue forecast toolkit 902 and a revenue forecast tool 903. The system 900 may be implemented as part of the enhanced data processing procedures described with respect to FIGS. 1-8. The revenue forecast toolkit 902 and the revenue forecast tool 903 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

The revenue forecast toolkit 902 may include a CPU processing system, which may be configured to implement enhanced data processing, as performed by the system 900. The CPU processing system of the revenue forecast toolkit 902 may include one or more processors 906 coupled to a computer readable medium/memory 904 (e.g., via a bus (not shown)). The one or more processors 906 and the computer readable medium/memory 904 may communicate via a message passing interface (MPI) 996. In certain aspects the computer readable /dium/ memory 904 is configured to store instructions (e.g., computer executable code) that when executed by the one or more processors 906, cause the one or more processors to perform the method 300 described with respect to FIG. 3, or any aspect related to it. Reference to a processor performing a function of system 900 may include one or more processors performing that function of system 900.

In the depicted example, computer-readable medium/memory 904 stores code 908 (e.g., executable instructions) for constructing, code 910 for identifying, code 912 for applying, code 914 for unioning, code 916 for comparing, code 918 for adjusting, code 920 for adding, code 922 for inputting, code 924 for outputting, and code 926 for performing at least one aspect of the present disclosure. Processing of code 908, 910, 912, 914, 916, 918, 920, 922, 924, and 926 may cause the system 900 to perform the method 300 described with respect to FIG. 3, or any aspect related to it.

The one or more processors 906 include circuitry configured to implement (e.g., execute) the code stored in the computer-readable medium/memory 904, including circuitry 928 for constructing, circuitry 930 for identifying, circuitry 932 for applying, circuitry 934 for unioning, circuitry 936 for comparing, circuitry 938 for adjusting, circuitry 940 for adding, circuitry 942 for inputting, circuitry 944 for outputting, and circuitry 946 for performing at least one aspect of the present disclosure. Processing with circuitry 928, 930, 932, 934, 936, 938, 940, 942, 944, and 946 may cause the system 900 to perform the method 300 described with respect to FIG. 3, or any aspect related to it.

The revenue forecast tool 901 may include a CPU processing system, which may be configured to implement enhanced data processing, as performed by system 900. The CPU processing system of the revenue forecast tool 901 may include one or more processors 905 coupled to a computer readable medium/memory 903 (e.g., via a bus (not shown)). The one or more processors 905 and the computer readable medium/memory 903 may communicate via a message passing interface (MPI) 995. In certain aspects the computer readable /dium/ memory 903 is configured to store instructions (e.g., computer executable code) that when executed by the one or more processors 905, cause the one or more processors to perform the method 300 described with respect to FIG. 3, or any aspect related to it. Reference to a processor performing a function of system 900 may include one or more processors performing that function of system 900.

In the depicted example, computer-readable medium/memory 903 stores code 907 (e.g., executable instructions) for displaying and code 909 for performing at least one aspect of the present disclosure. Processing of code 907 and 909 may cause the system 900 to perform the method 300 described with respect to FIG. 3, or any aspect related to it.

The one or more processors 905 include circuitry configured to implement (e.g., execute) the code stored in the computer-readable medium / memory 903, including circuitry 911 for displaying and circuitry 913 for performing at least one aspect of the present disclosure. Processing with circuitry 911 and 913 may cause the system 900 to perform the method 300 described with respect to FIG. 3, or any aspect related to it.

Various components of the system 900 may provide means for performing the method 300 described with respect to FIG. 3, or any aspect related to it.

The system 900 may include or be substantially coupled to a communication component 999. In the depicted example, the communication component 999 is an antenna capable of communicating with systems or system components similar to system 900 to perform the method 300 described with respect to FIG. 3, or any aspect related to it. In additional examples, the communication component 999 may be a bus or a wired connection.

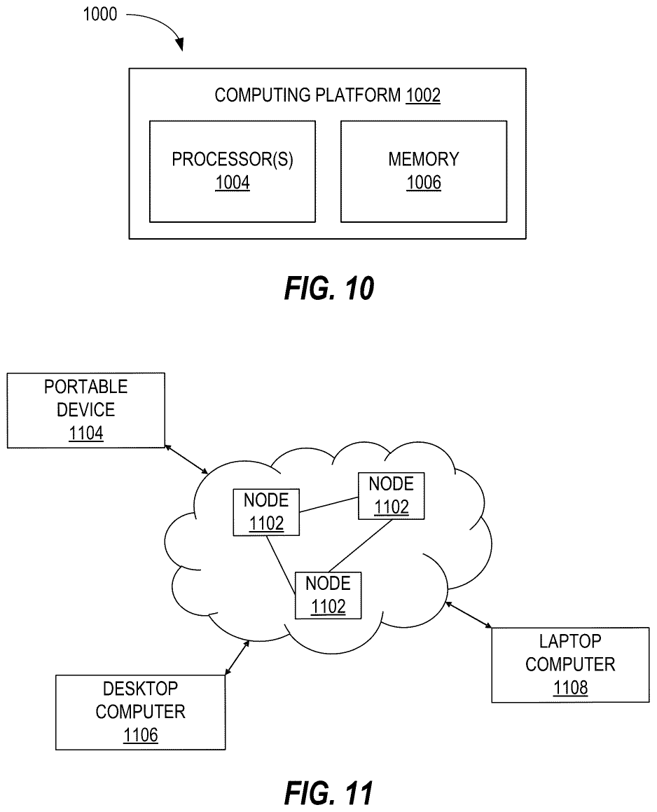

FIG. 10 is an example of a block diagram of a system 1000. System 1000 may be comparable to any of the enhanced data processing architecture of FIG. 1, the system of FIG. 6, the system 900 of FIG. 9, and the like. The system 1000 can be implemented using one or more modules, shown in block form in the drawings. The one or more modules can be in software or hardware form, or a combination thereof. In some examples, the system 1000 can be implemented as machine readable instructions for execution on one or more computing platforms 1002 (referred to as a computing platform herein), as shown in FIG. 10. The computing platform 1002 can include one or more computing devices selected from, for example, a desktop computer, a server, a controller, a blade, a mobile phone, a tablet, a laptop, a personal digital assistant (PDA), and the like.

The computing platform 1002 can include a processor 1004 and a memory 1006. By way of example, the memory 1006 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 1004 can be implemented, for example, as one or more processor cores. Memory 1006 can store machine-readable instructions that can be retrieved and executed by the processor 1004 to implement the system 1000 Each processor 1004 and memory 1006 can be implemented on a similar or a different computing platform. Computing platform 1002 can be implemented in a cloud computing environment (for example, as disclosed herein) and thus on a cloud infrastructure. In such a situation, features of computing platform 1002 can be representative of a single instance of hardware or multiple instances of hardware executing across the multiple of instances (e.g., distributed) of hardware (e.g., computers, routers, memory, processors, or a combination thereof). Alternatively, computing platform 1002 can be implemented on a single dedicated server or workstation.

In view of the structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

In view of the foregoing structural and functional description, those skilled in the art will appreciate that portions of the aspects may be embodied as a method, data processing system, or computer program product. Accordingly, these portions of the present aspects may take the form of an entirely hardware aspect, an entirely software aspect, or an aspect combining software and hardware, such as shown and described with respect to the computer system of FIG. 10. Furthermore, portions of the aspects may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain aspects have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

Although this disclosure includes a detailed description on a computing platform and/or computer, implementation of the teachings recited herein are not limited to only such computing platforms. Rather, aspects of the present disclosure are capable of being implemented in conjunction with any other type of computing environment now known or later developed.

Cloud computing is a model of service delivery for allowing convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

FIG. 11 is an example of a cloud computing environment 1100 that can be used for implementing one or more modules and/or systems in accordance with one or more examples, as disclosed herein. Thus, reference can be made to one or more examples of FIGS. 1-10 in the example of FIG. 11. As shown, cloud computing environment 1100 can include one or more cloud computing nodes 1102 with which local computing devices used by cloud consumers (or users), such as, for example, mobile phone, personal digital assistant (PDA), cellular, or portable device 1104, a desktop computer 1106, and/or a laptop computer 1108, may communicate. The computing nodes 1102 can communicate with one another. In some examples, the computing nodes 1102 can be grouped (not shown) physically or virtually, in one or more networks, such as Private, Community, Public, or Hybrid clouds, or a combination thereof. This allows the cloud computing environment 1100 to offer infrastructure, platforms and/or software as services for which a cloud consumer does not need to maintain resources on a local computing device. The devices 1104-1108, as shown in FIG. 11, are intended to be illustrative and that computing nodes 1102 and cloud computing environment 1100 can communicate with any type of computerized device over any type of network and/or network addressable connection (e.g., using a web browser). In some examples, the one or more computing nodes 1102 are used for implementing one or more examples disclosed herein relating to root-source identification. Thus, in some examples, the one or more computing nodes can be used to implement modules, platforms, and/or systems, as disclosed herein.

In some examples, cloud computing environment 1100 can provide one or more functional abstraction layers. It is to be understood that the cloud computing environment 1100 need not provide all of the one or more functional abstraction layers (and corresponding functions and/or components), as disclosed herein. For example, cloud computing environment 1100 can provide a hardware and software layer that can include hardware and software components. Examples of hardware components include: mainframes; RISC (Reduced Instruction Set Computer) architecture based servers; servers; blade servers; storage devices; and networks and networking components. In some aspects, software components include network application server software and database software.

In some examples, cloud computing environment 1100 can provide a virtualization layer that provides an abstraction layer from which the following examples of virtual entities may be provided: virtual servers; virtual storage; virtual networks, including virtual private networks; virtual applications and operating systems; and virtual clients. In some examples, cloud computing environment 1100 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1100, and billing or invoicing for consumption of these resources. In one example, these resources may include application software licenses. Security provides identity verification for cloud consumers and tasks, as well as protection for data and other resources. The management layer can also provide a user portal that provides access to cloud computing environment 1100 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, cloud computing environment 1100 can provide a workloads layer that provides examples of functionality for which cloud computing environment 1100 may be utilized. Examples of workloads and functions which may be provided from this layer include: mapping and navigation; software development and lifecycle management; virtual classroom education delivery; data analytics processing; and transaction processing. Various aspects of the present disclosure can utilize cloud computing environment 1100.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various aspects described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes in inputted into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

### Example Aspects

Implementation examples are described in the following numbered clauses:
Aspect 1: A system, including a data retriever implemented on a first unit configured to communicate over a data network with a second unit, a database coupled to the first unit and configured to store deal data, and a forecast toolkit implemented on the second unit configured to communicate over the data network with a remote computing device. The forecast toolkit including at least one of a future deal manager configured to identify, within a set of enhanced deal information, one or more future open deals, a machine learning engine, a forecast manager configured to union the one or more future open deals with an initial forecast to produce a second initial forecast, the initial forecast constructed by applying the machine learning engine to historical deal information, and a table builder configured to construct a predicted revenue output based on the second initial forecast.
Aspect 2: The system of aspect 1, wherein the remote computing device includes a forecast tool having a user-interface configured to enable a user to view revenue informatics based on a predicted revenue output on a display device and to make inputs to control visualization of the revenue informatics displayed to the user.
Aspect 3: The system of any one of aspects 1 through 2, wherein the data retriever includes at least one of an extractor configured to extract raw data from a source, a transformer configured to transform the raw data into structured data, and a load manager configured to deliver the structured data to the database.
Aspect 4: The system of aspect 3, wherein the structured data includes at least one of: a pipeline stage for each of a set of deals within the set of enhanced deal information.
Aspect 5: The system of any one of aspects 3 through 4, wherein the structured data includes at least one of: an owner for each of a set of deals within the set of enhanced deal information, a pipeline for each of a set of deals within the set of enhanced deal information, and a title for each of the set of deals within the set of enhanced deal information.
Aspect 6: The system of any one of aspects 3 through 5, wherein the structured data includes at least one of: a company for each of a set of deals within the set of enhanced deal information, a contact for each of the set of deals within the set of enhanced deal information, and a property history for each of the set of deals within the set of enhanced deal information.
Aspect 7: The system of any one of aspects 1 through 6, wherein the future deal manager is further configured to apply weights to the one or more future open deals based on a pipeline stage associated with each of the one or more future open deals.
Aspect 8: The system of any one of aspects 1 through 7, wherein the machine learning engine includes a training engine configured to train a machine learning model and an inference engine configured to apply the machine learning model to the historical deal information.
Aspect 9: The system of aspect 8, wherein the training engine is configured to train the machine learning model by: inputting a plurality of training data sets, the plurality of training data sets including at least one of known deal information and prior output of the machine learning model, including, to the plurality of training data sets, a plurality of outputs of the training engine, and, based on the comparing, adjusting one or more weights of the machine learning model.
Aspect 10: The system of any one of aspects 1 through 9, wherein the forecast manager is further configured to: apply a prioritization ranking to the second initial forecast to prioritize a future revenue types by month, and add closed pipeline information to the second initial forecast.
Aspect 11: A method, including: identifying, within a set of enhanced deal information, one or more future open deals, training a machine learning model including: inputting a plurality of training data sets, the plurality of training data sets comprising known deal information, comparing, to the plurality of training data sets, a plurality of outputs of a training engine, and based on the comparing, adjusting one or more weights of the machine learning model, unioning the one or more future open deals with a first initial forecast to produce a second initial forecast, the first initial forecast constructed by applying a machine learning engine to historical deal information, constructing a predicted revenue output based on the second initial forecast, and displaying, at a user interface, revenue informatics based on the predicted revenue output.
Aspect 12: The method of aspect 11, further including constructing the set of enhanced deal information based on a set of parameters.
Aspect 13: The method of aspect 12, wherein the set of parameters comprises a pipeline stage for each of a set of deals within the set of enhanced deal information.
Aspect 14: The method of any one of aspects 12 through 13, wherein the set of parameters includes at least one of an owner for each of a set of deals within the set of enhanced deal information, a pipeline for each of the set of deals within the set of enhanced deal information, and a title for each of the set of deals within the set of enhanced deal information.
Aspect 15: The method of any one of aspects 12 through 14, wherein the set of parameters includes at least one of a company for each of a set of deals within the set of enhanced deal information, a contact for each of the set of deals within the set of enhanced deal information, and a property history for each of the set of deals within the set of enhanced deal information.
Aspect 16: The method of any one of aspects 11 through 15, further including applying weights to the one or more future open deals based on a pipeline stage associated with each of the one or more future open deals.
Aspect 17: The method of claim 11, wherein the machine learning engine further includes an inference engine configured to apply the machine learning model to the historical deal information.
Aspect 18: The method of claim 11, wherein constructing the predicted revenue output based on the second initial forecast further includes: applying a prioritization ranking to the second initial forecast to prioritize a future revenue types by month, and adding closed pipeline information to the second initial forecast.
Aspect 19: An apparatus or device including a memory comprising executable instructions, and a processor configured to execute the executable instructions and cause the apparatus to perform a method in accordance with any one of aspects 11-18.
Aspect 20: An apparatus or device, including means for performing a method in accordance with any one of aspects 11-18.
Aspect 21: A non-transitory computer-readable medium including executable instructions that, when executed by a processor of an apparatus, cause the apparatus to perform a method in accordance with any one of aspects 11-18.
Aspect 22: A computer program product embodied on a computer-readable storage medium comprising code for performing a method in accordance with any one of aspects 11-18.

### Additional Considerations

The present disclosure may be a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular aspects only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary aspects, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to aspects of the disclosure without departing from the essential scope thereof. Therefore, it is intended that the disclosure not be limited to the particular aspects disclosed, or to the best mode contemplated for carrying out this disclosure, but that the disclosure will include all aspects falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A system, comprising:
a data retriever implemented on a first unit configured to communicate over a data network with a second unit;
a database coupled to the first unit and configured to store deal data; and
a forecast toolkit implemented on the second unit configured to communicate over the data network with a remote computing device, the forecast toolkit comprising at least one of:
a future deal manager configured to identify, within a set of enhanced deal information, one or more future open deals;
a machine learning engine configured to train a machine learning model by:
inputting a plurality of training data sets, the plurality of training data sets comprising at least one of known deal information and prior output of the machine learning model;
comparing, to the plurality of training data sets, a plurality of outputs of the training engine; and
based on the comparing, adjusting one or more weights of the machine learning model;
a forecast manager configured to union the one or more future open deals with an initial forecast to produce a second initial forecast, the initial forecast constructed by applying the machine learning engine to historical deal information; and
a table builder configured to construct a predicted revenue output based on the second initial forecast.

2. The system of claim 1, wherein the remote computing device includes a forecast tool having a user-interface configured to enable a user to view revenue informatics based on a predicted revenue output on a display device and to make inputs to control visualization of the revenue informatics displayed to the user.

3. The system of claim 1, wherein the data retriever comprises at least one of:
an extractor configured to extract raw data from a source;
a transformer configured to transform the raw data into structured data; and
a load manager configured to deliver the structured data to the database.

4. The system of claim 3, wherein the structured data includes at least one of: a pipeline stage for each of a set of deals within the set of enhanced deal information.

5. The system of claim 3, wherein the structured data includes at least one of: an owner for each of a set of deals within the set of enhanced deal information, a pipeline for each of a set of deals within the set of enhanced deal information, and a title for each of the set of deals within the set of enhanced deal information.

6. The system of claim 3, wherein the structured data includes at least one of: a company for each of a set of deals within the set of enhanced deal information, a contact for each of the set of deals within the set of enhanced deal information, and a property history for each of the set of deals within the set of enhanced deal information.

7. The system of claim 1, wherein the future deal manager is further configured to apply weights to the one or more future open deals based on a pipeline stage associated with each of the one or more future open deals.

8. The system of claim 1, wherein the machine learning engine comprises a training engine configured to train the machine learning model and an inference engine configured to apply the machine learning model to the historical deal information.

9. (canceled)

10. The system of claim 1, wherein the forecast manager is further configured to:
apply a prioritization ranking to the second initial forecast to prioritize a future revenue types by month; and
add closed pipeline information to the second initial forecast.

11. A method, comprising:
identifying, within a set of enhanced deal information, one or more future open deals;
training a machine learning model including:
inputting a plurality of training data sets, the plurality of training data sets comprising known deal information and prior output of the machine learning model;
comparing, to the plurality of training data sets, a plurality of outputs of a training engine; and
based on the comparing, adjusting one or more weights of the machine learning model;
unioning the one or more future open deals with a first initial forecast to produce a second initial forecast, the first initial forecast constructed by applying a machine learning engine to historical deal information;
constructing a predicted revenue output based on the second initial forecast; and
displaying, at a user interface, revenue informatics based on the predicted revenue output.

12. The method of claim 11, further comprising constructing the set of enhanced deal information based on a set of parameters.

13. The method of claim 12, wherein the set of parameters comprises a pipeline stage for each of a set of deals within the set of enhanced deal information.

14. The method of claim 12, wherein the set of parameters comprises at least one of an owner for each of a set of deals within the set of enhanced deal information, a pipeline for each of the set of deals within the set of enhanced deal information, and a title for each of the set of deals within the set of enhanced deal information.

15. The method of claim 12, wherein the set of parameters comprises at least one of a company for each of a set of deals within the set of enhanced deal information, a contact for each of the set of deals within the set of enhanced deal information, and a property history for each of the set of deals within the set of enhanced deal information.

16. The method of claim 11, further comprising applying weights to the one or more future open deals based on a pipeline stage associated with each of the one or more future open deals.

17. The method of claim 11, wherein the machine learning engine further comprises an inference engine configured to apply the machine learning model to the historical deal information.

18. The method of claim 11, wherein constructing the predicted revenue output based on the second initial forecast further comprises:
applying a prioritization ranking to the second initial forecast to prioritize a future revenue types by month; and
adding closed pipeline information to the second initial forecast.

19. A system, comprising:
a data retriever implemented on a first unit configured to communicate over a data network with a second unit;
a database coupled to the first unit and configured to store deal data; and
a forecast toolkit implemented on the second unit configured to communicate over the data network with a remote computing device, the forecast toolkit comprising at least one of:
a future deal manager configured to identify, within a set of enhanced deal information, one or more future open deals;
a machine learning engine configured to train a machine learning model by:
inputting a plurality of training data sets, the plurality of training data sets comprising at least one of known deal information and prior output of the machine learning model;
comparing, to the plurality of training data sets, a plurality of outputs of the training engine; and
based on the comparing, adjusting one or more weights of the machine learning model;
a forecast manager configured to:
union the one or more future open deals with an initial forecast to produce a second initial forecast, the initial forecast constructed by applying the machine learning engine to historical deal information;
apply a prioritization ranking to the second initial forecast to prioritize a future revenue types by month; and
add closed pipeline information to the second initial forecast; and
a table builder configured to construct a predicted revenue output based on the second initial forecast;
wherein the remote computing device includes a forecast tool having a user-interface configured to enable a user to view revenue informatics based on a predicted revenue output on a display device and to make inputs to control visualization of the revenue informatics displayed to the user.

20. The system of claim 19, wherein the prioritization ranking is based on a time associated with the one or more open deals, a classification associated with the one or more open deals, or both.
